(19) United States
(12) Patent Application Publication
(10) Pub. No.: US 2018/0001512 A1
(43) Pub. Date: Jan. 4, 2018

(54) Drill Ring for a Core Drill Bit

(71) Applicant: Hilti Aktiengesellschaft, Schaan (LI)

(72) Inventors: Matthias Mueller, Buchs (CH); Marcel Sonderegger, Balgach (CH)

(73) Assignee: Hilti Aktiengesellschaft, Schaan (LI)

(21) Appl. No.: 15/538,586

(22) PCT Filed: Dec. 16, 2015
(86) PCT No.: PCT/EP2015/079936

§ 371 Date: Jun. 21, 2017

(30) Foreign Application Priority Data
Dec. 22, 2014 (EP) 14199716.3

(51) Int. Cl. B28D 1/04; B23B 51/04; B28D 1/12

(52) U.S. Cl. CPC B28D 1/041; B28D 1/12; B23B 51/042; B23B 2226/31; B23B 2250/12; B23B 2226/75

(57) ABSTRACT

A drill ring for a cylindrical core drill bit is disclosed. The drill ring includes at least two ring segments which are constructed from a sintered powder mixture and diamond particles. The diamond particles are arranged on ablation tracks in a plane perpendicular to the cylinder axis and the ring segments are connected to each other on their lateral edges.

This application claims the priority of International Application No. PCT/EP2015/079936, filed Dec. 16, 2015, and European Patent Document No. 14199716.3, filed Dec. 22, 2014, the disclosures of which are expressly incorporated by reference herein.

### BACKGROUND AND SUMMARY OF THE INVENTION

The present invention relates to a drill ring for a core drill bit.

In the case of diamond tools, which are designed as core drill bits, a distinction is made between core drill bits with a continuous drill ring and segmented core drill bits with individual cutting segments. Core drill bits consist of a processing segment, a cylindrical drill shaft and a receiving segment with an insertion end. The core drill bit is fastened to the tool holder of a core drill by means of the insertion end and is driven by the core drilling device about a rotational axis during drilling operation.

Closed drill rings are produced from a powder mixture with statistically distributed diamond particles. The powder mixture is filled into a tool mold and pressed into a green part; the green part is sintered under temperature and pressure action to form a continuous drill ring. U.S. Pat. No. 5,316,416 discloses the construction of continuous drill rings which have good ablation properties over the entire height of the drill ring. The drill rings have a plurality of upper slots and lower slots distributed along the circumferential direction of the drill rings. The upper slots extend over half the height of the drill rings and open into the processing surface of the drill rings facing away from the drill shaft. The lower slots are arranged along the circumferential direction of the drill rings between the upper slots and open into the attachment surface of the drill rings facing the drill shaft. The upper and lower slots overlap at the height of the drill rings. By distribution of the upper and lower slots over the entire height of the drilling rings, a cooling and rinsing liquid is transported to the processing site over the entire operating time of the drill ring, and removed material is removed from the drilling area.

In the production of cutting segments for segmented core drill bits, in the professional sector a method has been established, in which the diamond particles are arranged in a predetermined setting pattern. A green part is built up layer by layer from powder coatings containing a powder mixture and diamond layers with diamond particles arranged in a setting pattern and then sintered under temperature and pressure action to the cutting segment. The cutting segments are arranged along a circumferential direction of the cylindrical drill shaft and welded, soldered and otherwise fixed to the drill shaft. The cutting speed which can be achieved with a segmented core drill bit depends essentially on the arrangement of the diamonds in the cutting segment. In the layered construction, the arrangement of the diamond particles can be influenced by the number of diamond layers, the distance between the diamond layers and the size of the diamond particles.

The object of the present invention consists of applying the technology of set diamonds to continuous drill rings and to increase the processing quality which can be achieved with the thus produced drill rings.

According to the invention, it is provided that the diamond particles are arranged in a plane perpendicular to the cylinder axis on circular ablation tracks and the ring segments are connected to one another at the side edges. The drill ring is constructed from at least two ring segments consisting of a sintered powder mixture and set diamond particles; the ring segments are connected to each other at the side edges in a force-locking or material-locking manner.

The properties of the ring segments can be adjusted via the powder mixture and the diamond particles. The set diamond particles are arranged on circular ablation tracks; successively arranged diamond particles describe the same ablation path during processing. For the processing of reinforced concrete materials, it has been found to be advantageous if the circular ablation tracks adjoin each other as much as possible.

In a preferred embodiment, the drill ring comprises a number of n, n≧1 first ring segments and n second ring segments, the first and second ring segments being arranged alternately one behind the other in a circumferential direction of the drill ring. The construction of the drill ring from the first and second ring segments allows adaptation to different substrates which are to be processed. In the case of core drilling in concrete materials with embedded rebar, which are also referred to as reinforced concrete materials, a drill ring encounters, for example, different substrates in the form of concrete and rebar.

Particularly preferably, the first ring segments have a diamond-coated area on the outer side and the second ring segments have a diamond-free area on the outer side. Due to the alternating arrangement of diamond-coated areas and diamond-free areas on the outside of the drill ring, the number of ablation tracks which the diamond particles describe during processing in the plane perpendicular to the cylinder axis increases. With the same number of diamond particles, more material can be removed and the performance of the drill ring is improved.

Particularly preferably, the first ring segments are constructed from a sintered first powder mixture and first diamond particles, and the second ring segments are constructed from a sintered second powder mixture and second diamond particles. The properties of the first ring segments can, for example, be adjusted to first substrate concrete, and the properties of the second ring segments can be adjusted to second substrate rebar. The properties of the ring segments can be adjusted, for example, via the powder mixture and the diamond particles. In the case of the diamond particles, the average diamond diameter, the diamond distribution and the number of diamond particles can be changed.

Particularly preferably, the first powder mixture of the first ring segments and the second powder mixture of the second ring segments are identical. Particularly preferably, the first diamond particles of the first ring segments and the second diamond particles of the second ring segments have the same diamond distribution and the same mean diamond diameter. The use of the same powder mixture and the same diamond particles can reduce the complexity of the apparatus during production of the drill ring; only one powder mixture and one variety of diamond particles are required.

Particularly preferably, the first diamond particles of the first ring segments are arranged in the plane perpendicular to the cylinder axis on a first number of first ablation tracks and the second diamond particles of the second ring segments are arranged on a second number of second ablation tracks. The number of diamond particles can be varied over the number of ablation tracks which corresponds to the number of diamond layers.

In a preferred variant, the first number of the first ablation tracks and the second number of the second ablation tracks are identical. The use of the same powder mixture, the same diamond particles, and the same number of diamond layers can reduce the complexity of the apparatus during production of the drill ring; only one variety of green parts is required.

Particularly preferably, the first radii of curvature of the first ablation tracks differ from the second radii of curvature of the second ablation tracks. Different radii of curvature lead to the number of ablation tracks increasing. If all radii of curvature are different, the number of ablation tracks of the drill ring is the sum of the first number of the first ablation tracks and the second number of the second ablation tracks.

Particularly preferably, the number of ablation tracks and the size of the diamond particles are set so that the mean diamond diameter of the diamond particles is at least 45% of the quotient of the drill ring width and the number of ablation tracks. For the processing of reinforced concrete materials, it has proven to be advantageous if the circular ablation tracks which the diamond particles describe during processing are as close as possible to one another and the rebar is almost completely removed by the diamond particles.

Particularly preferably, at least one water slot is provided between the ring segments. The height of the at least one water slot is between ⅓ and ⅚ of the total height of the drill ring. For drill rings that are welded to the drill shaft, the attachment area is constructed without diamonds and is unsuitable for processing. The matrix zone, which is provided with diamond particles and is approximately ⅚ of the total height of the drill ring, is suitable for the processing of substrates.

Particularly preferably, the height of the at least one water slot is set to ⅔ of the total height of the drill ring. At a proportion of ⅔ of the total height, sufficient strength of the finished drill ring can be ensured. During processing with the drill ring, cooling liquid must be transported to the processing site; therefore the water slots in the drill ring are designed to be as long as possible.

Particularly preferably, at least one ring segment has a bore which connects the inner and outer sides of the drill ring. The bore is particularly preferably at least partially arranged below the at least one water slot. The additional bore ensures sufficient cooling of the drill ring when the at least one water slot is removed.

Embodiments of the invention are described below with reference to the drawings. This is not intended to illustrate the exemplary embodiments on to scale, but the drawings are executed schematically and/or slightly distorted. With regard to supplements to the teachings directly recognizable from the drawings, reference is made to the relevant prior art. It should be understood that various modifications and changes in the form and detail of an embodiment may be made without departing from the general idea of the invention. The features of the invention disclosed in the description, the drawings as well as the claims may be essential both individually and in any combination for the further development of the invention. Moreover, all combinations of at least two of the features disclosed in the description, the drawings and/or the claims fall within the scope of the invention. The general idea of the invention is not restricted to the exact form or detail of the preferred embodiment shown and described below, nor restricted to an object which would be limited in comparison to the subject matter asserted in the claims. In the case of given design ranges, values within the limits mentioned are also to be disclosed as limiting values and can be used and claimed as desired. For the sake of simplicity, reference numerals are subsequently used below for identical or similar parts or parts with the same or similar function.

### BRIEF DESCRIPTION OF THE DRAWINGS

FIG. 1 illustrates a core drill bit consisting of a drill ring, a cylindrical drill shaft and a receiving segment;

FIGS. 2A-C illustrate a first embodiment of a drill ring according to the invention, which is constructed from four ring segments, in a three-dimensional representation (FIG. 2A), in a cross-section perpendicular to the axis of rotation (FIG. 2B) and in a detail enlargement (FIG. 2C);

FIG. 3 illustrates a second embodiment of a drill ring according to the invention, which is constructed from four ring segments with water slots; and

FIGS. 4A-D illustrate the production of the drill ring of FIG. 3 of four identical green parts with a hexagonal base surface (FIG. 4A), wherein two green parts are formed into concave first ring portions and two green parts are formed into convex second ring segments (FIG. 4B), the first and second ring segments are arranged alternately one behind the other along a circumferential direction (FIG. 4C) and combined under temperature and pressure action to form a continuous drill ring (FIG. 4D).

### DETAILED DESCRIPTION OF THE DRAWINGS

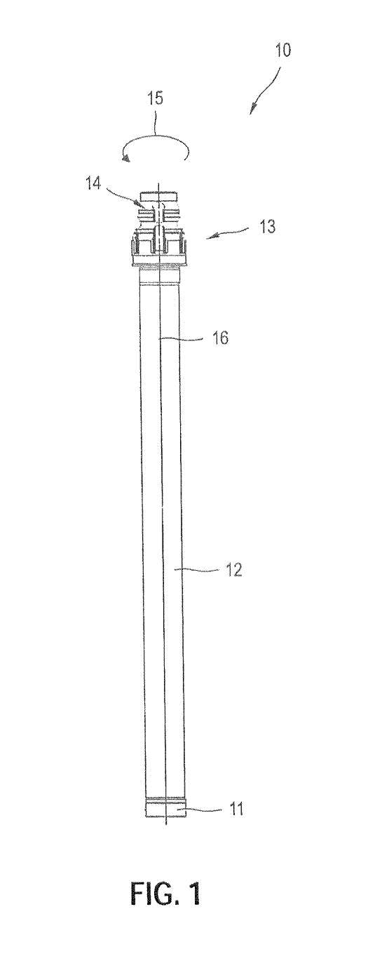

FIG. 1 shows a core drill bit 10 with a drill ring 11, a cylindrical drill shaft 12 and a receiving segment 13 with an insertion end 14. The core drill bit 10 is fastened via the insertion end 14 in the tool receptacle of a core drilling device and during drilling operation is driven by the core drilling device in a rotary direction 15 about a rotary axis 16, wherein the axis of rotation 16 is coaxial with the cylinder axis of the core drill bit 10.

The drill ring 11 is welded, brazed, or screwed to the drill shaft 12, or fixed to the drill shaft 12 in another suitable manner of attachment. In order to be able to weld the drill ring 11 with the drill shaft 12, the connecting area between the drill ring 11 and the drill shaft 12 must be made of a weldable material and must not contain any diamond particles, as diamond particles cannot be welded.

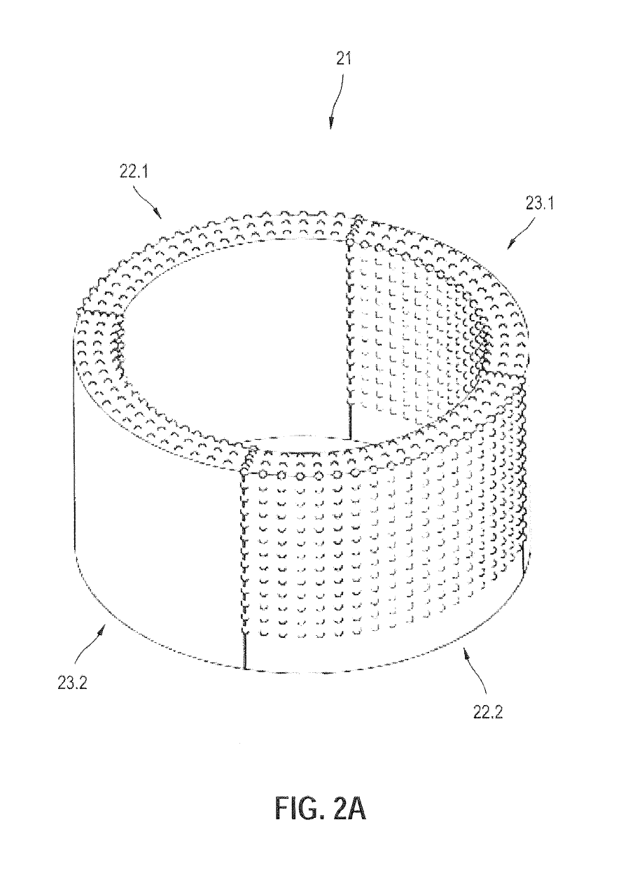

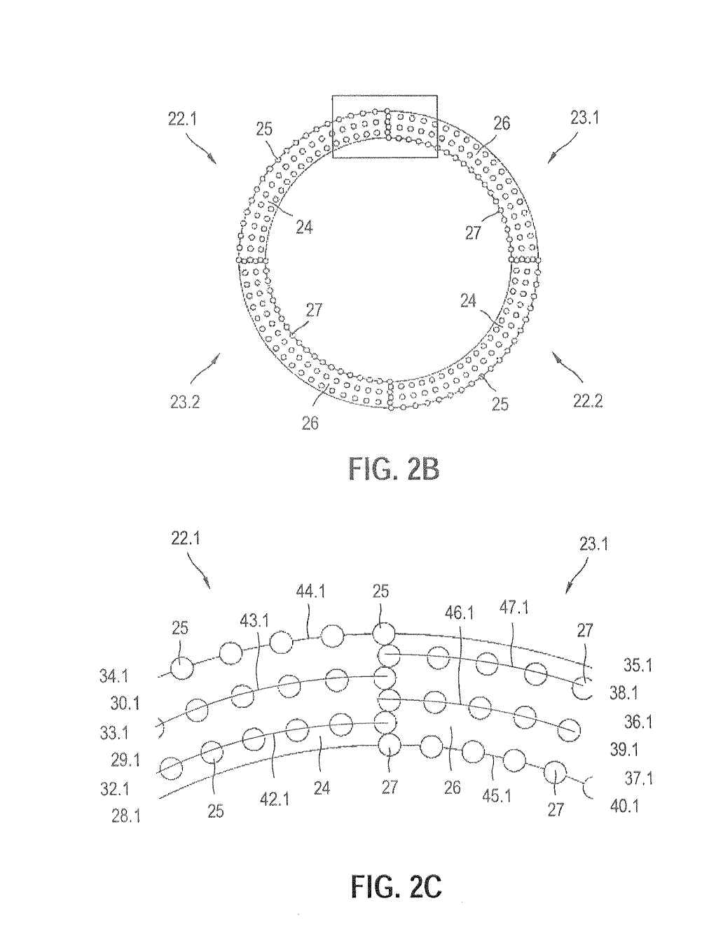

FIGS. 2A-C show a first embodiment of a drill ring 21 according to the invention, which is composed of a plurality of ring segments and which can replace the drill ring 11 of the core drill bit 10 of FIG. 1. FIG. 2A shows the drill ring 21 in a three-dimensional representation, FIG. 2B shows the drill ring 21 in a cross-section perpendicular to the axis of rotation 16, and FIG. 2C shows a detail from the cross-section of FIG. 2B in the connection area between two ring segments.

The drill ring 21 is composed of four ring segments which are connected to one another at the side edges and form a closed ring in the circumferential direction (FIG. 2A). The ring segments of the drill ring 21 can be divided into two first ring segments 22.1, 22.2 and two second ring segments 23.1, 23.2 which are arranged alternately one behind the other along a circumferential direction of the drill ring 21. The first ring segments 22.1, 22.2 consist of a first powder mixture 24 and first diamond particles 25, and the second ring segments 23.1, 23.2 consist of a second powder mixture 26 and second diamond particles 27 (FIG. 2B).

FIG. 2C shows a detail from the cross-section of FIG. 2B in the connection region between the first ring segment 22.1 and the second ring segment 23.1. The first ring segment 22.1 is constructed of a number of m₁ powder coatings of the first powder mixture 24 and m₁ of diamond layers of the first diamond particles 25. The second ring segment 23.1 is constructed of a number of m₂ powder coatings of the second powder mixture 26 and m₂ diamond layers of the second diamond particles 27. In this exemplary embodiment, the first ring segment 22.1 m₁=3 powder layers 28.1, 29.1, 30.1 and m₁=3 diamond layers 32.1, 33.1, 34.1 and the second ring segment 23.1 has m₂=3 powder layers 35.1, 36.1, 37.1 and m₂=3 diamond layers 38.1, 39.1, 40.1.

The first diamond particles 25 of the diamond layers 32.1-34.1 are arranged on three circular first ablation tracks 42.1, 43.1, 44.1 with different first radii of curvature R₁ᵢ, i=1, 2, 3. The second diamond particles 27 of the diamond layers 38.1-40.1 are arranged on three circular second ablation tracks 45.1, 46.1, 47.1 with different second radii of curvature R₂ᵢ, i=1, 2, 3. The selection of the materials for the first and second powder mixtures 24, 26, the selection of the diamond distribution and size for the first and second diamond particles 25, 27, and the number m₁, m₂ of the diamond layers and the ablation tracks make it possible to adapt the drill ring 21 to different substrates to be processed.

The ring segments 22.1, 22.2, 23.1, 23.2 are constructed in layers from three powder layers and three diamond layers. In a layered configuration, the powder mixture is filled into a matrix and forms the first powder layer. The diamond particles are placed in a set pattern as a first diamond layer on the first powder layer. In order to densify the layer structure, intermediate pressing can take place after placing the diamond particles. Subsequently, the powder mixture is filled into the matrix and forms the second powder layer. The diamond particles are placed in a set pattern as a second diamond layer on or in the second powder layer. This process is repeated until the desired height of the green part is reached. A diamond layer is used as the last layer.

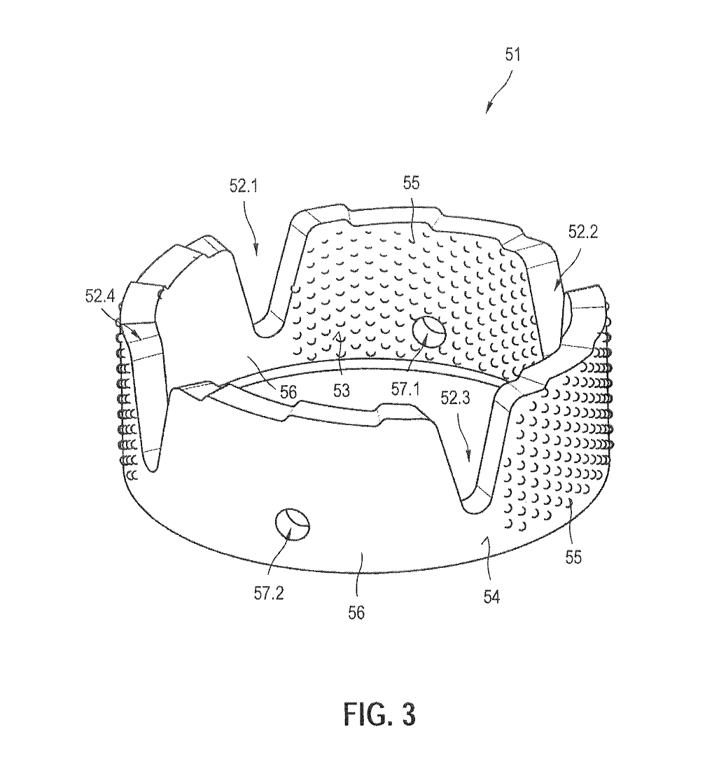

FIG. 3 shows a second embodiment of a drill ring 51 according to the invention which consists of four ring segments and can replace the drill ring 11 of the core drill bit 10. Four water slots 52.1, 52.2, 52.3, 52.4 are formed between the ring segments, via which a cooling liquid is transported to the processing site. The ring segments are arranged in such a way that the drill ring 51 alternately has a diamond-coated area 55 and a diamond-free area 56 on the inside 53 and on the outside 54.

The water slots 52.1-52.4 extend over a height of approximately ⅔ of the total height of the drill ring 51. In order to ensure the operational capability of the drill ring 51 even if the water slots 52.1-52.4 are removed, two ring segments have a bore 57.1, 57.2 via which cooling liquid is transported to the processing site.

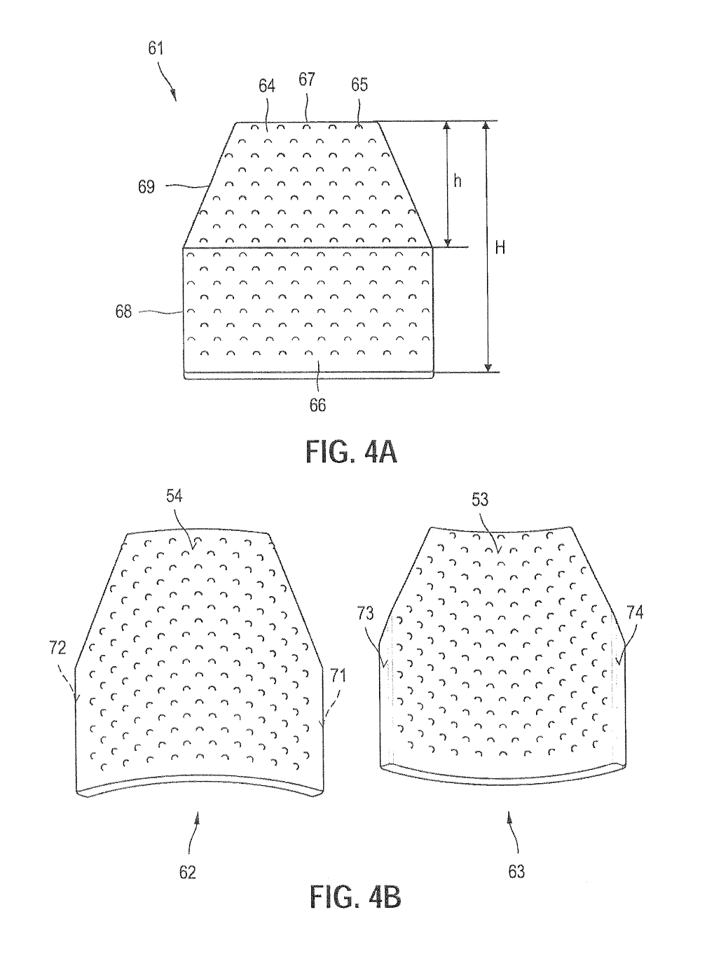

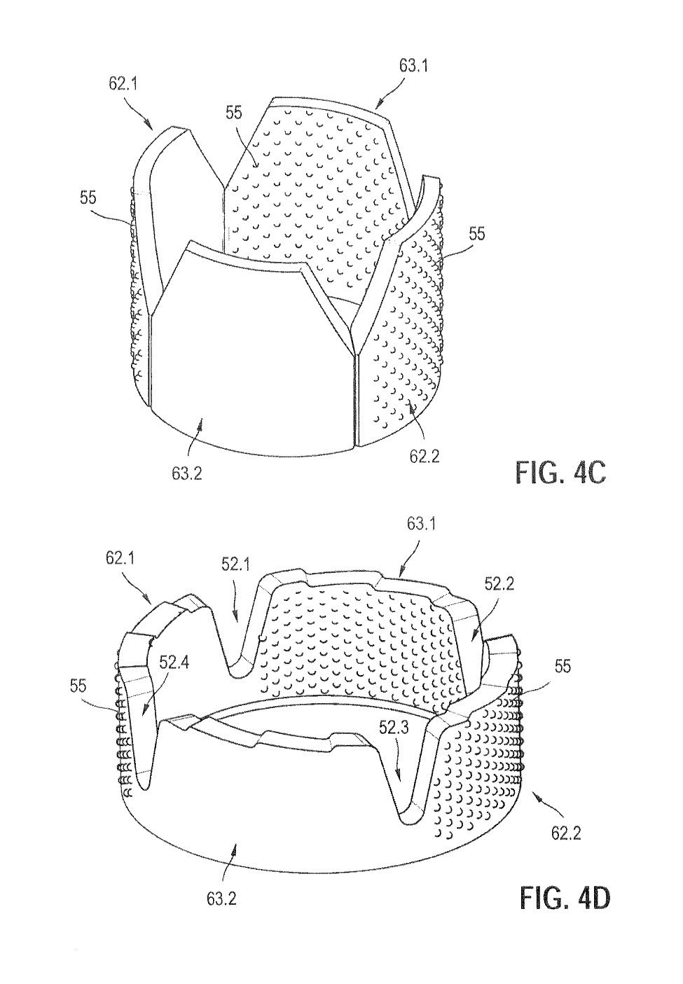

FIGS. 4A-D show the production of the drill ring 51 from four identical green parts 61 with a hexagonal base surface (FIG. 4A). Two green parts 61 are formed into concave first ring segments 62 and two green parts 61 are formed into convex second ring segments 63 (FIG. 4B). The first and second ring segments 62, 63 are arranged alternately one behind the other along a circumferential direction of the drill ring 51 (FIG. 4C) and sintered under a temperature and pressure action to form a continuous drill ring (FIG. 4D).

FIG. 4A shows the construction of the green part 61 which has been produced in powder layers from a powder mixture 64 and diamond layers of diamond particles 65. The green part 61 consists of an attachment area 66, which is also referred to as a footer zone, and a processing area 67, which is also referred to as a matrix zone. The attachment area 66 and the processing area 67 can be constructed jointly in layers, wherein no diamond particles 65 are placed in the connecting area. As an alternative, the attachment area can be produced as a separate area and can be connected to the processing area during sintering.

The base surface of the green parts 61 is hexagonal and consists of a rectangle 68 and an adjacent isosceles trapezoid 69, wherein the attachment area 66 of the green part 61 is located in the rectangle 68. In the region of the legs of the trapezoid, the water slots 52.1-52.4 are formed during sintering by additional pressure action, via which the cooling liquid is transported to the processing site. The height h of the trapezoid 69 in the green part defines the height of the water slot 52.1-52.4. In the exemplary embodiment, the height h of the trapezoid 69 corresponds to half the total height H of the green part.

FIG. 4B shows the first ring segment 62, which was created under pressure action with a convex curvature from the green part 61 of FIG. 4A, and the second ring segment 63, which was created under pressure action with a concave curvature from the green part 61 of FIG. 4A. In the case of the first ring segment 62, the upper side of the green part 61, which is formed as a diamond layer, is arranged on the outer side 54, and in the second ring segment 63, the upper side of the green part 61 is arranged on the inner side 53.

The first ring segment 62 has first and second side edges 71, 72 which are joined to a first and second side edge 73, 74 of the second ring segment 63 during sintering. The first side edge 71 of the first ring segment 62 is connected to the second side edge 74 of the second ring segment 63, and the second side edge 72 of the first ring segment 62 is connected to the first side edge 73 of the second ring segment 63. In the drill ring 51 with two first and second ring segments 62.1, 62.2, 63.1, 63.2, the first and second side edges of the adjacent ring segments are connected to each other.

FIG. 4C shows the first ring segments 62.1, 62.2 and second ring segments 63.1, 63.2 arranged alternately one behind the other along a circumferential direction of the drill ring 51. The ring segments 62.1, 63.1, 62.2, 63.2 form a continuous drill ring and, arranged in the position shown in FIG. 4C, are processed further in a hot press. FIG. 4D shows the continuous drill ring after hot pressing. During hot pressing, the ring segments 62.1, 63.1, 62.2, 63.2 are subjected to temperature and pressure action.

The temperature action ensures that the powder mixture is sintered in the ring segments and the ring segments are connected to one another at the side edges. Pressure in the axial direction, i.e., parallel to the axis of rotation of the drill ring, causes compression of the ring segments, which leads to densification of the ring segments. Hot pressing is carried out in a die which defines the final shape of the drill ring.

1.-13. (canceled)

14. A drill ring for a cylindrical core drill bit, comprising:
at least two ring segments constructed from a sintered powder mixture and diamond particles;
wherein the diamond particles are respectively disposed on circular ablation tracks in a plane perpendicular to an axis of the cylindrical core drill bit;
wherein the at least two ring segments are connected to each other at respective side edges.

15. The drill ring according to claim 14, wherein the drill ring includes n≧1 first ring segments and n second ring segments and wherein the first and the second ring segments are alternately disposed one behind the other along a circumferential direction of the drill ring.

16. The drill ring according to claim 15, wherein the first ring segments have a diamond-coated area and the second ring segments have a diamond-free area on a respective outer side.

17. The drill ring according to claim 15, wherein the first ring segments are constructed from a sintered first powder mixture and first diamond particles and wherein the second ring segments are constructed from a sintered second powder mixture and second diamond particles.

18. The drill ring according to claim 17, wherein the sintered first powder mixture and the sintered second powder mixture are identical.

19. The drill ring according to claim 17, wherein the first diamond particles and the second diamond particles have a same diamond distribution and a same mean diamond diameter.

20. The drill ring according to claim 17, wherein the first diamond particles are disposed in the plane perpendicular to the axis on a first number of first ablation tracks and wherein the second diamond particles are disposed on a second number of second ablation tracks.

21. The drill ring according to claim 20, wherein the first number of first ablation tracks and the second number of second ablation tracks are identical.

22. The drill ring according to claim 20, wherein first radii of curvature of the first ablation tracks differ from second radii of curvature of the second ablation tracks.

23. The drill ring according to claim 22, wherein the number of ablation tracks and a size of the diamond particles are set such that an average diamond diameter of the diamond particles is at least 45% of a quotient of a width of the drill ring and the number of ablation tracks.

24. The drill ring according to claim 14, wherein at least one water slot is disposed between the at least two ring segments.

25. The drill ring according to claim 24, wherein a height of the at least one water slot is between ⅓ and ⅚ of a total height of the drill ring.

26. The drill ring according to claim 14, wherein at least one ring segment of the at least two ring segments has a bore which connects an inner side and an outer side of the drill ring.
